(19) United States
(12) Patent Application Publication
(10) Pub. No.: US 2002/0088216 A1
(43) Pub. Date: Jul. 11, 2002

(54) AUTOMATIC ON-BOARD LUBRICATION SYSTEM FOR COTTON HARVESTING MACHINES

(76) Inventors: Michael J. Horejsi, Sherrard, IL (US); F. Randall Hugh, Geneseo, IL (US); Jesse H. Orsborn, Port Byron, IL (US)

Correspondence Address: NEW HOLLAND NORTH AMERICA, INC., P. O. BOX 1895, M.S. 641, 500 DILLER AVENUE, NEW HOLLAND, PA, 17557, US

(21) Appl. No.: 09/843,328

(22) Filed: Apr. 26, 2001

Related U.S. Application Data
(60) Provisional application No. 60/260,513, filed on Jan. 9, 2001.

(51) Int. Cl. A01D 69/12; A01D 46/08

(52) U.S. Cl. 56/12.3; 56/28

(57) ABSTRACT

An improved cotton harvester having a plurality of harvesting mechanisms, each harvesting mechanism having at least one light grease receiving area including a picker bar having a plurality of rotatably driven picker spindles, and at least one heavy grease receiving area including a cam and a roller arrangement and a gear arrangement for drivingly oscillating the picker bar, and an automatic lubrication system for periodically lubricating the light grease receiving area with a light grease at a first pressure, the improvement including a heavy grease reservoir on the harvester for receiving a quantity of a heavy grease; a pump on the harvester having an inlet connected to the heavy grease reservoir and a discharge, the pump being operable for drawing the heavy grease from the heavy grease reservoir and discharging the heavy grease from the discharge at a second pressure which is substantially greater than the first pressure, the discharge being connected to one end of at least one high pressure lubricant line having another end including at least one opening or outlet disposed for discharging the heavy grease to the at least one heavy grease receiving area; and a controller connected to the pump for operating the pump for causing the heavy grease to flow through the at least one high pressure lubricant line and discharge through the opening to the at least one heavy grease receiving area.

This application claims the benefit of U.S. Provisional Application No. 60/260,513, filed Jan. 9, 2001.

### TECHNICAL FIELD

The present invention generally relates to cotton harvesting machines and, more particularly, to systems and apparatus for automatically providing proper amounts of different types of lubricants to various lubricant receiving areas of a cotton harvester during desired time periods.

### BACKGROUND ART

A typical cotton harvesting machine or harvester includes two or more harvesting units for harvesting cotton from rows of cotton plants during a harvesting procedure. Each harvesting unit includes one or more rotatable harvesting mechanisms comprised of multiple inter-related parts. A typical harvesting unit including two harvesting mechanisms has a pair of picker rotor assemblies with doffer assemblies arranged in combination therewith. Each picker rotor assembly includes a series of upright picker bars capable of being oscillated about their respective upright axes. Each picker bar has a plurality of picker spindles arranged thereon one above the other. The picker spindles of each picker bar are rotatably driven by a driving arrangement within the picker bar. A driving arrangement, typically including a cam and individual followers or rollers on the picker bars, transmits rotary motion from an input drive shaft to the picker bars to drive them along a predetermined path of travel defined by the profile of the cam while concurrently rotating the picker spindles. During forward motion of the machine, the picker spindles are brought into contact with the cotton plants to remove the cotton. The doffer assemblies then remove the cotton from the picker spindles. The doffer assemblies are also rotated by a driving arrangement about their respective upright axes, and include pairs of opposing doffer pads between which the individual picker spindles are passed to remove the cotton therefrom. The picker spindles then pass through a picker spindle moistening assembly including a series of vertically arranged moistening pads for adding moistening fluid to each of the picker spindles before they are introduced to the cotton plant again. After removal from the picker spindles, the cotton is blown by fans through ducts to a large basket located on the harvesting machine.

During the harvesting operation, it is usually desired to minimize damaging the individual strands or filaments of the cotton, as their integrity and length are important determinants of the quality and thus value of the cotton crop. To facilitate good picking, the rotational speeds of the above discussed elements of the harvesting mechanisms are closely timed with respect to the forward speed of the harvesting machine, such that the picker spindles will be introduced to the cotton plants at an appropriate counter speed such that the cotton will not be unnecessarily damaged. During this time, the picker spindles themselves are rotating at a controlled speed, and include small barbs that come into contact with the cotton to hold it while removing it from the plant.

To ensure proper functioning of the harvesting mechanism components, and prolong the useful lives thereof, it is known to utilize an automatic lubricating system for the harvesting mechanisms. Reference in this regard, Reichen et al. U.S. Pat. No. 4,769,978, issued Sep. 13, 1988 to Deere & Company which discloses a lubrication distribution system for cotton harvester row units that utilizes a single constant displacement pump to distribute a single lubricant under pressure to harvesting unit lubrication points, including cams, picker bar cam tracks, picker drum drive gears, the picker drum thrust washer area, and the picker spindle bushings. Reference also Deutsch U.S. Pat. No. 4,840,018, issued Jun. 20, 1989 to Deere & Company which discloses a lubrication distribution system for a cotton harvester which provides a high volume of lubricant to the drum bars of the harvesting units and a low volume of the lubricant to the gears and cams for moving the picker bars.

A significant shortcoming observed with use of the above referenced lubrication systems, however, is that only a single, relatively light lubricant such as a light grease is used for lubricating all of the above named components of the harvesting unit, including the gears and cams of the driving arrangements for rotatably driving the components, which are subject to relatively high loads, and the picker bar components, which are relatively lightly loaded. A relatively light lubricant, namely, a light grease, is used, as it would be difficult to introduce a heavier lubricant into the lubricant requiring areas of the picker rotor assemblies, particularly for lubricating the picker spindles, and a heavier lubricant, particularly a heavy grease, if used in those areas, would unacceptably increase the power requirements of the picker rotor assemblies. And, if a heavy grease were introduced under pressure to those areas, a danger could be present that the heavy grease would be forced out though seals around the picker spindles and contaminate the cotton, which would decrease its value. The power requirements for rotating the picker bar components would also vary depending on the amount of the heavy grease present thereon and thus with the cycles of the lubrication system.

Additionally, it has been found that it is not satisfactory to use the light lubricant for lubricating the heavily loaded components of the harvesting mechanisms, because due to the lightness of the lubricant, it is easily squeezed and displaced from the load bearing surfaces such as gear teeth and the cam and roller surfaces, resulting in poor lubrication and thus greater wear and shortened life of those components. This problem is compounded by the temperatures at which cotton is often harvested, which can exceed 100 degrees F., resulting in increased susceptibility of squeezing and displacement of the lubricant from the loaded bearing surfaces.

Another shortcoming of the above referenced types of automatic lubrication systems for cotton harvesting mechanisms that has been found is that, ideally, the heavily loaded components of the driving arrangements and the lightly loaded components of the picker bar components are best lubricated on different periodic schedules. That is, it has been found that the heavily loaded components are best lubricated with a heavy grease periodically during the harvesting operation, for instance, hourly, whereas the picker bar components are best lubricated using a light grease before the harvesting operation, for instance, during and/or after the warm up period for the harvesting mechanisms, such that the operating characteristics of the harvesting mechanisms are more uniform and less affected by the lubrication cycle.

In the past, it has been known to utilize automatic lubrication systems using light grease for lubricating the lightly loaded components of the harvesting mechanisms, while relying on manual greasing of the heavily loaded components. However, a shortcoming of this approach is that time that could be used for harvesting is devoted to the manual greasing operation. Also, the greasing is only as reliable as the person doing it, and the tendency is to perform the greasing either before or at the end of a day of harvesting, which as discussed above, has been found to be less effective than greasing periodically while harvesting.

Typically, the harvesting units are connected to a tool bar structure which extends laterally across a forward end of the cotton harvester. The tool bar structure is connected to the frame or chassis of the harvester by a pivoting lift assembly which allows the tool bar structure and harvesting units to pivotally move about a horizontal axis upon their vertical displacement relative to the frame or chassis so as to maintain a substantially constant parallel orientation relative to the ground surface. For reliable, problem-free operation and long life, the pivot elements of the lift assembly must also be periodically lubricated.

Each fan for blowing the cotton into the basket is typically rotatably driven using a pulley arrangement including an idler pulley mounted on an idler arm which is pivotally movable to engage the idler pulley with a moving belt. The fan is supported for rotation by fan bearings. The fan bearings and the idler arm pivot should likewise also be periodically lubricated so as to provide a long service life.

It has been found that the pivots of the lift assembly, and the fan components are best lubricated using a heavy grease. However, again, if done manually, the greasing is only as reliable as the person assigned to that job. Also, many of these components are located at difficult to reach locations on the harvester, such as beneath the operator cab of the harvester, and/or under the basket, making them difficult to access.

Accordingly, it would be desirable to provide a cotton harvester including an automatic lubrication system which overcomes the shortcomings and problems discussed above.

### SUMMARY OF THE INVENTION

According to the invention, an improved cotton harvester is disclosed having a plurality of harvesting mechanisms, each harvesting mechanism having at least one light grease receiving area including a picker bar having a plurality of rotatably driven picker spindles, and at least one heavy grease receiving area including a cam and a roller arrangement and a gear arrangement for drivingly oscillating the picker bar, and an automatic lubrication system for periodically lubricating the light grease receiving area with a light grease at a first pressure, wherein the improvement comprises a heavy grease reservoir on the harvester for receiving a quantity of a heavy grease; a pump on the harvester having an inlet connected to the heavy grease reservoir and a discharge, the pump being operable for drawing the heavy grease from the heavy grease reservoir and discharging the heavy grease from the discharge at a second pressure which is substantially greater than the first pressure, the discharge being connected to one end of at least one high pressure lubricant line having another end including at least one opening or outlet disposed for discharging the heavy grease to the at least one heavy grease receiving area; and a controller connected to the pump for operating the pump for causing the heavy grease to flow through the at least one high pressure lubricant line and discharge through the opening to the at least one heavy grease receiving area.

### BRIEF DESCRIPTION OF THE DRAWINGS

A non-limiting embodiment of the present invention will be described by way of example with reference to the accompanying drawings, in which:

FIG. 1 is a simplified partial side elevational view of a cotton harvester according to the present invention;

FIG. 2 is simplified side elevational schematic representation of a harvesting unit of the harvester of FIG. 1 showing harvesting mechanisms thereof and lubricant lines thereto;

FIG. 3 is a simplified top schematic representation of the harvesting unit of FIG. 2 showing components of the harvesting mechanisms and the lubricant lines connected to elements of an automatic lubricating system of the harvester;

FIG. 4 is a simplified side elevational view of lift assembly and fans of the harvester of FIG. 1 showing lubricant lines thereto;

FIG. 5 is a simplified rear elevational view of the fans of FIG. 4 showing additional lubricant lines thereto;

FIG. 6 is a simplified schematic representation of the lubricating system of the harvester showing heavy grease distributing elements of the system; and

FIG. 6A is another schematic representation of the lubricating system showing additional heavy grease distributing elements of the system.

### Detailed Description Of The Invention

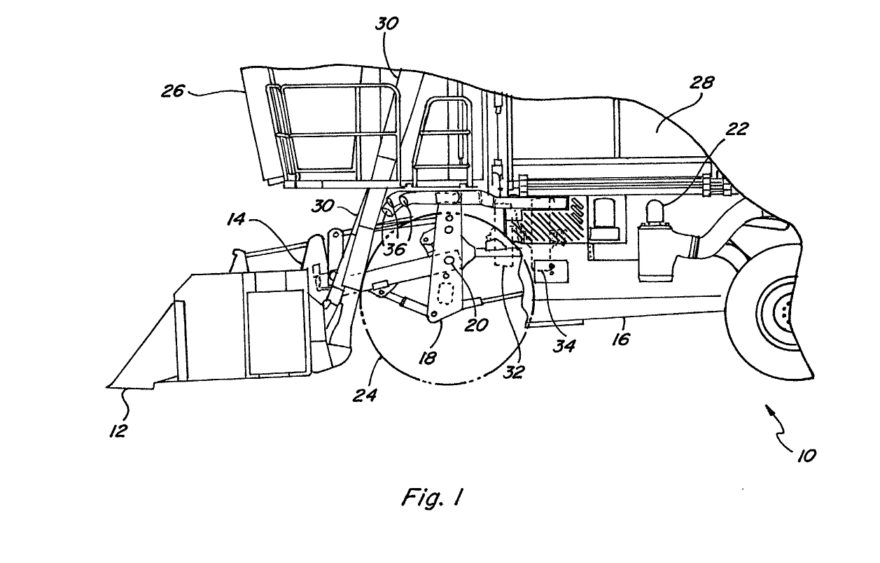

Referring now to the drawings, wherein a preferred embodiment of the present invention is shown, FIG. 1 illustrates a cotton harvester 10 equipped with a plurality of harvesting units, represented by a harvesting unit 12, mounted in side-by-side relation on a tool bar structure 14 which extends laterally across a forward end of the cotton harvester 10. Tool bar structure 14 is connected to a chassis or frame 16 of cotton harvester 10 by a pivoting lift assembly 18 which allows tool bar structure 14 and harvesting units 12 to pivotally move about a generally horizontal laterally extending axis 20 upon vertical displacement thereof relative to frame 16 so as to maintain a substantially constant parallel orientation relative to a ground surface (not shown) over which cotton harvester 10 is driven for harvesting cotton from cotton plants (also not shown) in the well known manner. Cotton harvester 10 additionally includes a conventional internal combustion power plant 22 supported on frame 16 for supplying driving power to at least a pair of forwardly located drive wheels 24 (illustrated in phantom). An operator cab 26 is located above drive wheels 24 forwardly of a large basket 28 for receiving cotton picked by harvesting units 12 via a plurality of ducts 30 extending therebetween. Briefly, in operation, the cotton is conveyed from harvesting units 12 through ducts 30 to basket 28 by air flows generated by a front fan 32 and a rear fan 34 located on frame 16, the air being directed to the respective harvesting units 12 by a plurality of air ducts 36 (shown partially removed) which extend between fans 32, 34 and the respective harvesting units 12.

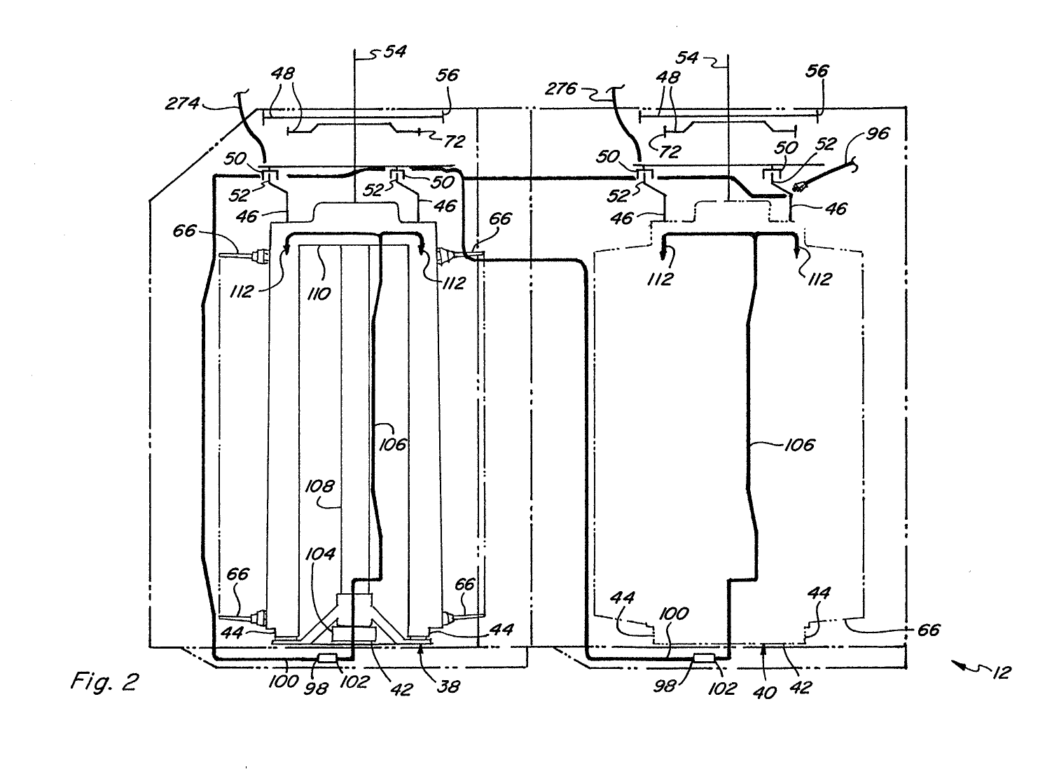

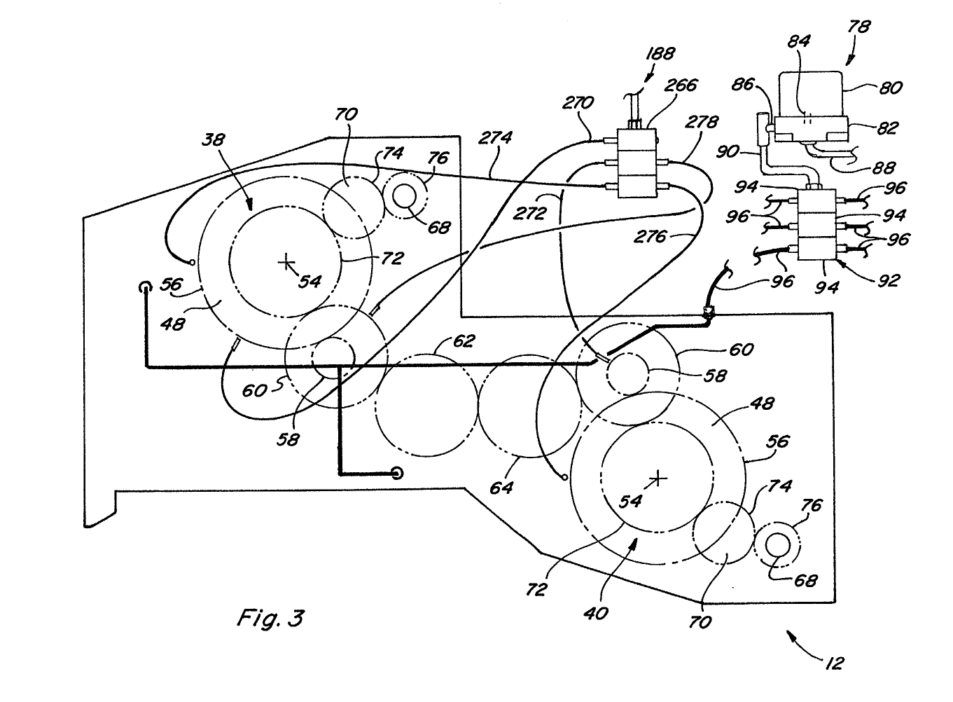

Referring also to FIGS. 2 and 3, wherein representative harvesting unit 12 is illustrated, it being understood that the following explanation applies to each of the harvesting units, harvesting unit 12 includes a front harvesting mechanism 38 and a rear harvesting mechanism 40. Each of the harvesting mechanisms 38, 40 includes a picker drum or picker rotor assembly 42 of conventional construction including a series of upright picker bars 44 capable of being oscillated about respective upright axes 46 thereof along the profile of a cam 50 by a driving arrangement 48, picker bars 44 including rollers 52 which follow the cam profile as the picker rotor assembly 42 is rotated about an upright axis 54 thereof. Driving arrangement 48 includes a rotor drive gear 56 mounted to each picker rotor assembly 42, enmeshed with a transfer gear 58 mounted to a transfer gear 60 which, in turn, is enmeshed either with another transfer gear 62 or an input gear 64 connected to an input drive shaft (not shown) connected with a rotating drive source (also not shown) which receives power from power plant 22 in the well known conventional manner. Each picker bar 44 includes a plurality of picker spindles 66 arranged one above the other and rotatably driven by a driving arrangement (not shown) within the picker bar 44, driven by driving arrangement 48 concurrent with the rotation of the picker rotor assemblies 42 and the oscillation of picker bars 44. The enmeshed relationship of rotor drive gears 56, transfer gears 58, 60, 62, and input gear 64, serves to time the rotation of the picker rotor assemblies 42 with the rotation of the input drive shaft, so as to be in a known ratiometric relationship to the forward speed of cotton harvester 10, with the result that picker spindles 66 will be introduced to a cotton plant at a forward speed corresponding closely with the forward speed of cotton harvester 10, such that the picker spindles 66 can gently retrieve the cotton therefrom. Picker spindles 66 include small barbs (not shown) that contact the cotton to hold it while it is removed from the plant.

Each harvesting mechanism 38, 40 additionally includes a conventional doffer assembly 68 associated with each picker rotor assembly 42, each doffer assembly 68 including pairs of opposing doffer pads (not shown) between which the individual picker spindles 66 are passed to remove the cotton therefrom. Each doffer assembly 68 is rotated by a driving arrangement 70 including a gear 72 rotatably about axis 54 of the associated picker rotor assembly 42, enmeshed with transfer gear 60 and with another transfer gear 74 which, in turn, is enmeshed with a doffer drive gear 76 fixedly mounted to a bar of the respective doffer assembly 68 for drivingly rotating it.

Once the cotton is removed from the picker spindles 66 by the doffer assemblies 68, the air flow from the front fan 32 or rear fan 34 ducted to that harvesting mechanism 38, 40 will carry the cotton through the associated duct 30 and deposit the cotton in basket 28.

As discussed above, to maintain the integrity of the cotton to the greatest extent possible, and thus the quality thereof, it is desired that picker rotor assemblies 42 of harvesting mechanisms 38, 40 operate smoothly at desired speeds in relation to the driving speed of cotton harvester 10. Cotton harvesting operations are often conducted under arid and hot environmental conditions, with temperatures typically being within a range of from 100° F. to 120° F. To ensure smooth, reliable operation and long service life of the internal rotating components of picker rotor assemblies 42, particularly picker spindles 66 and the driving arrangements therefor, without unduly increasing the power requirements thereof, it is desired to use a light lubricant, such as a NLGI 00 rated light grease for those components. Use of a light grease is advantageous as it flows readily, thereby only minimally impacting power requirements for rotating picker rotor assemblies 42, and it requires less delivery pressure to be effectively distributed throughout the internal cavities of picker rotor assemblies 42. The contact surfaces between the internal driving and driven elements of picker rotor assemblies 42 are also relatively lightly loaded, such that a light grease serves as an effective lubricant.

Conversely, it has been found that gears 56, 58, 60, 62, and 64 of driving arrangements 48 for picker rotor assemblies 42, and gears 72, 74, 76 of driving arrangements 70 for doffer assemblies 68, are relatively heavily loaded members, and thus are best lubricated with a heavier lubricant, such as a NLGI 1 rated heavy grease, a NLGI 2 rated heavy grease, or an NLGI 3 rated heavy grease. In this regard, it has been found that light greases are easily squeezed from between the enmeshed teeth of the gears, particularly under hot environmental conditions, resulting in premature wear and failure. Premature wear can result in excessive gear backlash, which can reduce the smoothness and uniformity of rotation of the driven picker rotor assemblies 42 and doffer assemblies 68 under varying load conditions, resulting in diminished operability thereof.

To provide automatic lubrication of light grease receiving areas of harvesting units 12, which include the internal components of picker bars 44, including picker spindles 66 and the driving arrangements therefor, cotton harvester 10 includes an automatic light grease lubrication system 78. Automatic light grease lubrication system 78 includes a light grease reservoir 80 for receiving a quantity of a light grease, a light grease pump 82 having an inlet 84 connected to the light grease reservoir 80, and a discharge 86. Light grease pump 82 is of conventional construction and operation, and can be powered using any suitable conventional means, such as by connection via a wire 88 to a switched power lead of the electrical system (not shown) of cotton harvester 10. Light grease pump 82 is operable when energized to draw the light grease from light grease reservoir 80 and discharge the light grease through discharge 86 at a relatively high volume and low pressure, usually less than about 200 pounds per square inch (psi). Discharge 86 is connected in fluid communication to one end 90 of a network 92 of light lubricant lines including a divider valve 94 connected to individual light lubricant lines 96 extending to the respective harvesting units 12 and having openings 98 at ends 100 thereof connected in sealed fluid communication with grease inlets 102 of picker rotor assemblies 42 of harvesting mechanisms 38, 40. In turn, each grease inlet 102 is connected in fluid communication with an internal cavity of a thrust bearing housing 104 of the picker rotor assembly 42 for providing light grease thereto. Another light lubricant line 106 is connected at one end to the internal cavity of thrust bearing housing 104 by a passage through a portion of a central rotor shaft 108 of each picker rotor assembly 42, and at another end in fluid communication with an internal cavity of a rotor head 110, which in turn is in fluid communication with internal cavities of the individual picker bars 44 of the rotor assembly 42, for providing a path for the flow of the light grease thereto, as denoted by arrows 112.

Automatic light grease lubrication system 78 can be operated at any time, but preferably during a special lubricating cycle after warm up of the cotton harvester 10 and prior to commencement of the harvesting operation. During the lubrication cycle, the picker rotor assemblies 42 are preferably rotated within a specific rotational speed range as the light grease is discharged therein as denoted by arrows 112. System 78 can be operated manually during this time, or controlled using a suitable conventional timer. Then, as an option, the timer can be used to illuminate a signal light or other indicator to warn when another lubricating cycle is required. This ensures uniform lubrication of picker spindles 66 and substantially eliminates any variations in the operating characteristics of harvesting mechanisms 38, 40, as a result of lubrication.

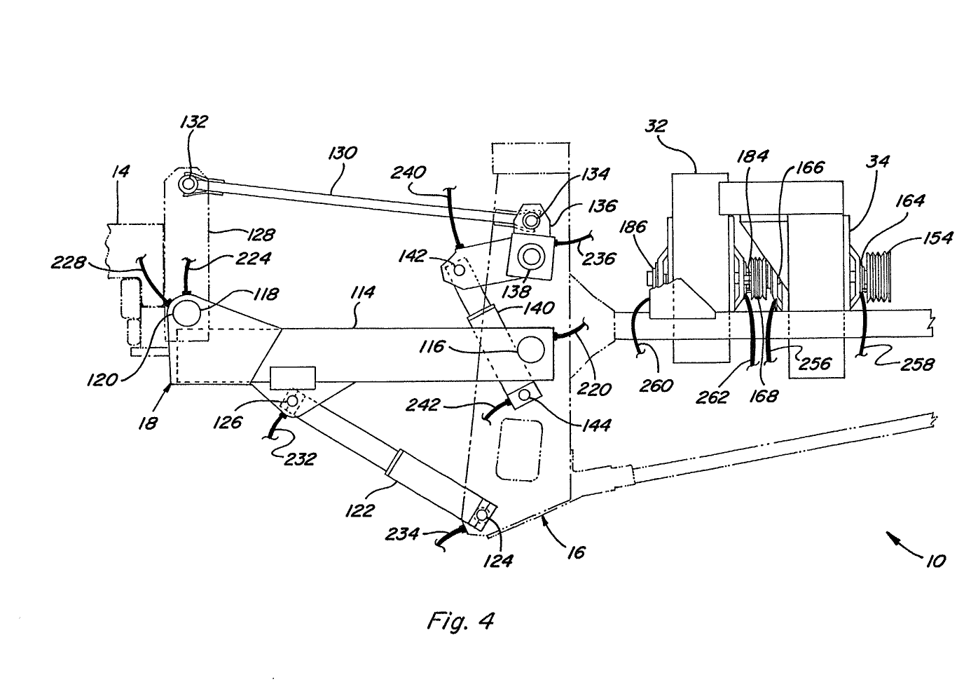

Referring also to FIG. 4 and as noted above, frame 16 of cotton harvester 10 supports a lift assembly 18 operable for pivotally moving tool bar structure 14 carrying harvesting units 12 during vertical displacement thereof relative to frame 16, for maintaining harvesting units 12 in a substantial constant parallel orientation relative to the ground surface during the harvesting operation. Lift assembly 18 includes several left hand side and right hand side structural elements when viewed from the rear, including a pair of parallel lift arms, which will be discussed only in terms of the left hand side elements for brevity, it being understood that the discussion applies also to the right hand side elements. Lift assembly 18 includes a left lift arm 114 pivotally connected to frame 16 by a left lift arm pivot 116. Left lift arm 114 has an opposite or distal end including a left tool bar pivot 118 and a laterally extending left tool bar retainer pivot 120 adapted for engaging and holding tool bar 14 for pivotal movement relative to left lift arm 114. A left lift cylinder 122 is pivotally connected at one end to frame 16 by a left lower lift cylinder pivot 124, and is pivotally connected at an opposite end to left lift arm 114 by a left upper lift cylinder pivot 126, cylinder 122 being operable for pivoting left lift arm 114 about left lift arm pivot 116 for raising and lowering tool bar 14 and harvesting units 12 located thereon. Left tool bar pivot arm 128 is fixedly connected at one end to left tool bar retainer pivot 120 for pivotal movement therewith about left tool bar pivot 118, and includes an opposite end pivotally connected to a front end of a radius rod 130 by a left tool bar retainer pivot 132. Left radius rod 130 has a rear end pivotally connected by a left rear radius rod pivot 134 to one end of a rock shaft arm 136. Rock shaft arm 136 is an L shape member pivotally connected at one end to frame 16 by a left rock shaft pivot 138 and a right rock shaft pivot (not shown), and includes an opposite end pivotally connected to an upper end of a rock shaft cylinder 140 by a rock shaft cylinder upper pivot 142. Rock shaft cylinder 140 has a lower end connected to frame 16 by a rock shaft cylinder lower pivot 144, rock shaft cylinder 140 being operable in cooperation with left lift cylinder 122 for maintaining harvesting units 12 in the desired parallel orientation relative to the ground surface while being raised and lowered.

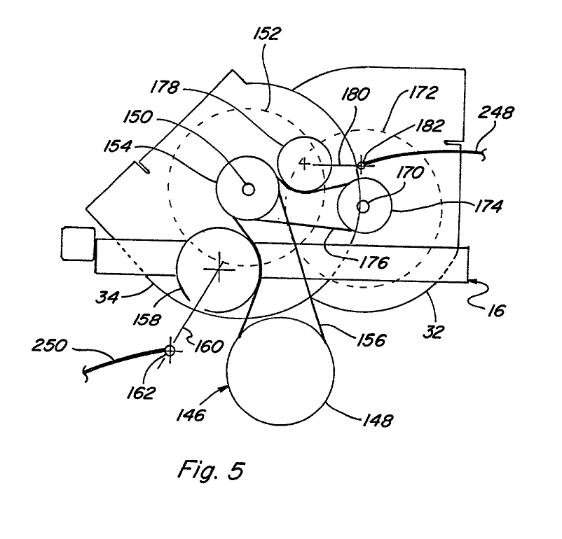

Referring also to FIG. 5, as noted above, front fan 32 and rear fan 34 are located on frame 16 of cotton harvester 10, just rearwardly of lift assembly 18. Fans 32, 34 are each rotated by a driving arrangement 146 including a main drive pulley 148 rotatably driven by power plant 22 (FIG. 1) either directly, or through a hydraulic motor or the like. Rear fan 34 includes a shaft 150 extending therethrough which supports a blower fan 152 and a drive pulley 154 for rotation therewith. Main drive pulley 148 and drive pulley 154 are encircled by an endless belt set 156 to allow rotation of fan 152 by main drive pulley 148. An idler pulley 158 is mounted for rotation on one end of a rear idler arm 160, rear idler arm 160 including an opposite end pivotally mounted to frame 16 by a rear idler arm pivot 162. Idler pulley 158 is urged against belt set 156 by a biasing member (not shown) such as a spring or fluid cylinder acting against rear idler arm 160 for maintaining tension in belt set 156. Shaft 150 of rear fan 34 is supported for rotation within a housing of the fan by a rear fan rear bearing 164 and a rear fan front bearing 166, and includes a transfer pulley 168 mounted for rotation therewith. Front fan 32 includes a shaft 170 having a blower fan 172 and a drive pulley 174 mounted for rotation therewith. An endless transfer belt set 176 encircles transfer pulley 168 and drive pulley 174 for rotatably driving shaft 170 and fan 172. An idler pulley 178 is mounted for rotation on one end of a front idler arm 180 pivotally mounted to frame 16 by a front idler arm pivot 182, and is biased against belt set 176 for maintaining tension therein. Shaft 170 is supported for rotation in a housing of front fan 32 by a front fan rear bearing 184 and a front fan front bearing 186.

The various pivots of lift assembly 18 are very heavily loaded components, as they support and allow articulation of tool bar structure 14 and harvesting units 12, which are heavy. These components are also subject to severe environmental conditions including dust and hot temperatures. Rear idler arm pivot 162, front idler arm pivot 182, and the fan bearings 164, 166, 184, and 186, are also subject to heavy loading and the severe environmental conditions. As noted previously in reference to FIG. 1, all of these components are at difficult to access locations beneath operator cab 26 and basket 28 of cotton harvester 10.

As noted above, in the past, it has been customary to periodically manually lubricate the lift arm and fan grease points with a heavy grease, and either manually grease the heavily loaded harvesting unit components using a heavy grease, or automatically lube them using a light grease when the rotor or drum assemblies are lubed, before operation or during service intervals. However, due to the severe loading and environmental conditions, it has also been found to be highly advantageous to lubricate these components more frequently, and during the operation thereof, utilizing a heavy lubricant, such as a NLGI 1 rated heavy grease, a NLGI 2 rated heavy grease, or a NLGI 3 rated heavy grease. Likewise, driving arrangements 48 for the picker rotor assemblies 42, including cams 50, rollers 52, gears 56, 58, 60, 62, and 64, and driving arrangements 70 for doffer assemblies 68, including gears 72, 74, and 76, are also subjected to heavy loads, it having been found that these components are better lubricated using a heavy grease, such as one of those listed above, also frequently during the operation thereof. Because of the advantages observed by lubricating these components on a frequent basis during the harvesting operation, they are categorized as heavy grease receiving areas. Advantages achieved by lubrication of the heavy grease receiving areas with a heavy grease on a frequent periodic basis include better operation; long, reliable service life; and greater machine and operator productivity due to reduction in operating time otherwise required for lubrication. It has also been found that by using smaller quantities of the lubricant delivered at more frequent intervals, preferably about hourly or so, less of the heavy grease is required for satisfactory lubrication for a given operating period.

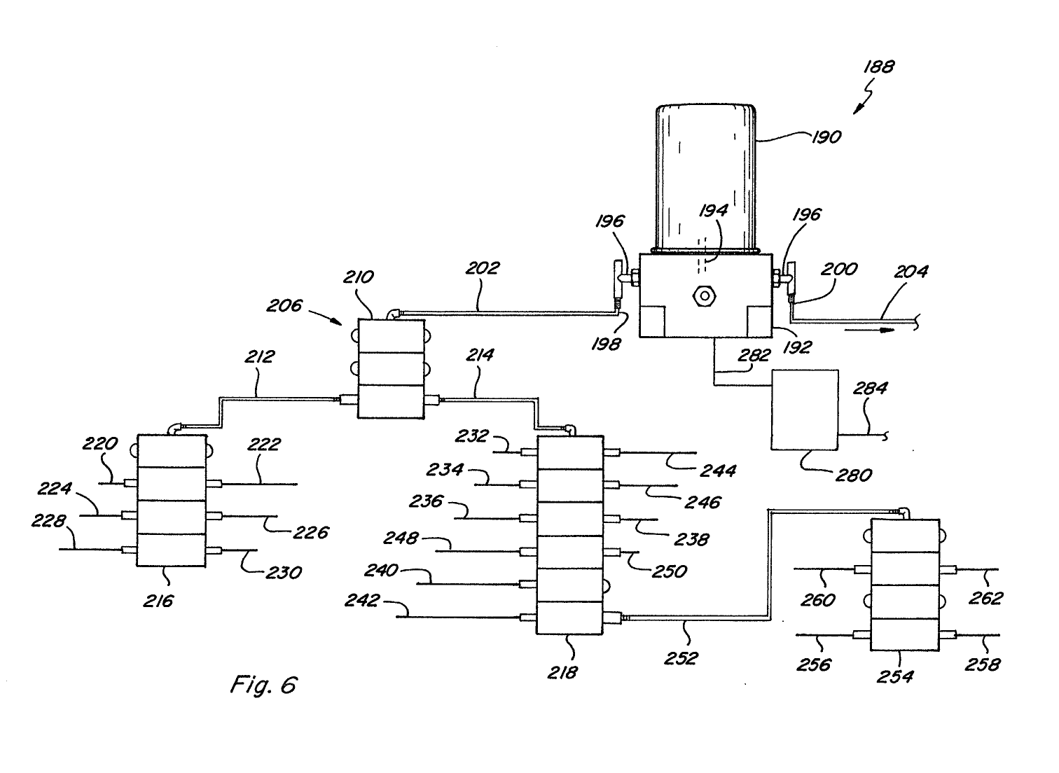

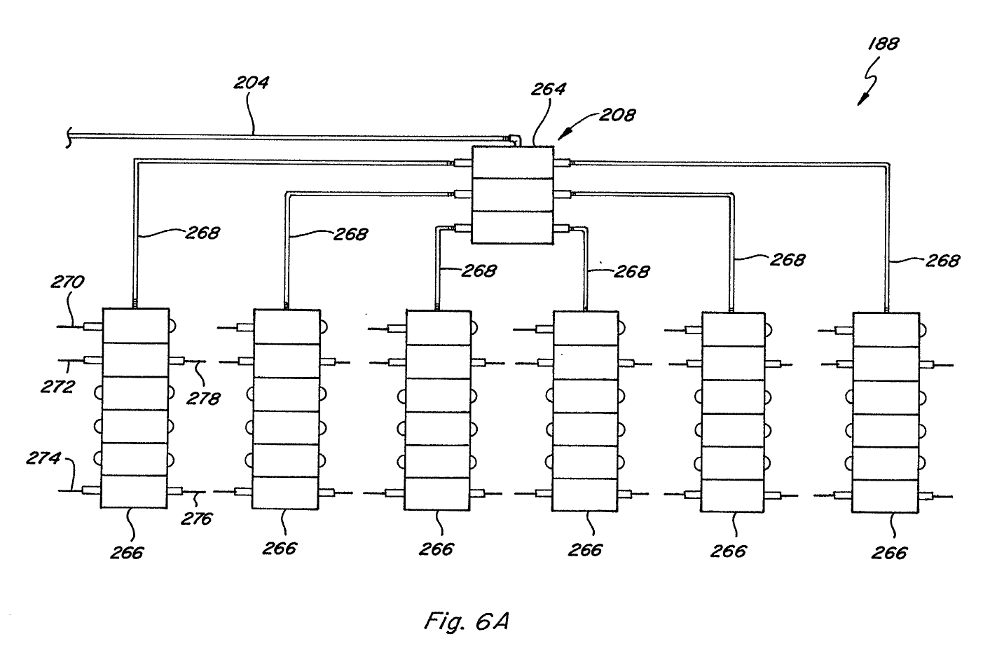

Referring also to FIGS. 6 and 6A, cotton harvester 10 includes an automatic heavy grease lubrication system 188, operable to distribute heavy grease to the heavy grease receiving areas on a selected periodic basis. Referring more particularly to FIG. 6, heavy grease lubrication system 188 includes a heavy grease reservoir 190 for receiving and holding a quantity of a heavy grease, a heavy grease pump 192 having an inlet 194 connected to heavy grease reservoir 190 for receiving the heavy grease therefrom, and a pair of heavy grease discharge outlets 196 through which the heavy grease can be discharged under a high pressure of about 1000 psi or higher. Heavy grease discharge outlets 196 are connected, respectively, to inlet ends 198 and 200 of high pressure lubricant lines 202 and 204 of heavy grease distributing networks 206 and 208, respectively. Networks 206 and 208 can be constructed of conventional fluid handling componentry, such as commercially available hydraulic lines and the like, as long as the components are able to operate under and withstand the high pressures used. Conversely, the light lubricant lines and other components of system 78 can be of lighter construction, for instance, a light duty plastic tubing, suitable for the much lower pressures encountered during the operation of that system. As will be explained, heavy grease distributing network 206 includes a plurality of high pressure lubricant lines for delivering the pressurized heavy grease to the heavy grease receiving areas of lift assembly 18 and fans 32, 34, while heavy grease distributing network 208 includes a plurality of high pressure lubricant lines for delivering the heavy grease to driving arrangements 48 and 70 of harvesting units 12. Here, it should be understood that a high delivery pressure will be required for introducing the heavy grease into the pivots of lift assembly 18 due to the fits of the pins, bushings, sleeves, and other parts thereof, as well as the high loading between those components, whereas the required pressures for delivery of the heavy grease to the other heavy grease receiving areas will be lower, equal essentially only to that pressure required to overcome the high viscosity and resultant resistance to flow of the heavy grease itself.

Heavy grease distributing network 206 includes a primary divider valve 210 connected to line 202 for receiving the heavy grease under pressure therefrom and operating to sequentially deliver the grease to high pressure lubricant lines 212 and 214 connected to secondary divider valves 216 and 218, respectively. Secondary divider valve 216, in turn, is connected to a high pressure lubricant line 220 having an outlet disposed for delivering the heavy grease discharged therethrough to left lift arm pivot 116; a high pressure lubricant line 222 having an outlet for discharging grease to the right lift arm pivot (not shown); a high pressure line 224 having an outlet disposed for discharging the heavy grease to left tool bar pivot 118; a high pressure line 226 having an outlet for distributing the heavy grease to the right tool bar pivot (not shown); a high pressure line 228 having an outlet for discharging the heavy grease to tool bar retainer pivot 120; and a line 230 having an outlet for discharging the heavy grease to the right tool bar retainer pivot (not shown). Secondary divider valve 218 is also connected to a plurality of high pressure lubricant lines, including a line 232 having an outlet for discharging the heavy grease to left upper lift cylinder pivot 126; and a line 234 having an outlet for discharging the heavy grease to left lower lift cylinder pivot 124. For lubricating the rock shaft components, divider valve 218 is connected to a high pressure line 236 for discharging the heavy grease to the left rock shaft pivot 138; a line 238 for discharging the heavy grease to the right rock shaft pivot; a line 240 for discharging the heavy grease to rock shaft cylinder upper pivot 142; and a line 242 for discharging the heavy grease to rock shaft cylinder lower pivot 144. For lubricating the upper and lower pivots of the right lift cylinder (not shown), divider valve 218 is connected to a line 244 and a line 246 for discharging the heavy grease to those components, respectively. For lubricating the fan components, divider valve 218 is connected to a line 248 for discharging the heavy grease to front idler arm pivot 182; and a line 250 for discharging the heavy grease to rear idler arm pivot 162. Divider valve 218 is also connected to a line which distributes the heavy grease to another secondary divider valve 254, which in turn is connected to lines 256, 258, 260, and 262, for discharging the heavy grease to fan bearings 164, 166, 186, and 184, individually.

Referring more particularly to FIG. 6A, high pressure lubricant line 204 is connected to a primary divider valve 264 for distributing the heavy grease to a plurality of identical secondary divider valves 266 via a plurality of high pressure lubricant lines 268. In turn, the individual divider valves 266 distribute the grease to the heavy grease receiving areas of harvesting units 12, respectively, of which there are a total quantity of six on the present cotton harvester 10. As with the harvesting units, an explanation of the connections of a single divider valve 266 will suffice to explain the connections of the other valves 266. Referring also to FIG. 3, wherein representative divider valve 266 is shown in simplified form in association with representative harvesting unit 12, valve 266 is connected to a grease carrying line 270 having an outlet end disposed within a cabinet of unit 12 for discharging the heavy grease onto the teeth of rotor drive gear 56 of driving arrangement 48 of front harvesting mechanism 38. Rotation of drive gear 56 and the enmeshed contact thereof with transfer gear 58 will then distribute some of the grease onto the teeth of that gear. Valve 266 is connected to a line 272 having an outlet end disposed for discharging the heavy grease onto the teeth of transfer gear 58 of driving arrangement 48 of rear harvesting mechanism 40, so as to be distributed also to the teeth of rotor drive gear 56 of mechanism 40 during rotation thereof. Valve 266 is connected to a line 274 having an outlet end disposed for discharging the heavy grease onto cam 50 of driving arrangement 48 of front harvesting mechanism 38, so as to be distributed also to rollers 52 of the individual picker bars 44 engaged therewith. Similarly, valve 266 is connected to a line 276 having an outlet end disposed for discharging the heavy grease onto cam 50 of driving arrangement 48 of rear harvesting mechanism 40, so as to be distributed also to rollers 52 of the individual picker bars 44 engaged therewith.

Finally, valve 266 is connected to a grease carrying line 278 having an outlet end disposed for discharging the heavy grease onto the teeth of transfer gear 60 of driving arrangement 48 of front harvesting mechanism 38. Rotation of drive gear 60 and the enmeshed contact thereof with transfer gear 62 and gear 72 will carry some of the grease to those gears. Some of the grease will then be carried by gear 62 to input gear 64, which will then distribute some of the grease onto the teeth of transfer gear 60 of driving arrangement 48 of rear harvesting mechanism 40, which will, in turn, carry some of the grease to gear 72. Gear 72 will carry some of the grease to transfer gear 74 of driving arrangement 70 for the associated doffer assembly 68, which will carry some of the grease to doffer drive gear 76. In the same manner, the grease on the teeth of gear 72 of the front mechanism 38 will be carried to gears 74 and 76 of driving arrangement 70 for doffer assembly 68 associated therewith.

As discussed, it has been found to be highly advantageous to lubricate each of the heavy grease receiving areas of harvester 10 on a relatively frequent periodic basis, generally about hourly, during the operation thereof. This is accomplished in part by the nature of the operation of the various divider valves of system 188, which divider valves are of conventional construction and operation to sequentially and proportionally distribute the grease to the lines connected thereto as governed by specially sized pistons within the valves which are moved by the pressure of the grease in relation to opposing ports leading to opposing lines, for opening the ports to allow grease flow thereto, and for closing the ports when a predetermined quantity of grease has passed therethrough. Referring to FIG. 6, the timing of the distribution of the grease is also controlled in part by the operation of heavy grease pump 192, which is controllably operated by a controller 280 connected thereto by wire 282, which is connected to a source of electrical energy such as the electrical system of harvester 10, by wire 284.

Controller 280 includes control circuitry which can include simply a conventional timer, and/or an interlock with the control circuitry of harvester 10, and/or a processor, for operating pump 192 only when harvester 10 is in a selected operating mode or modes, namely, the harvesting mode. By selection of appropriately sized pistons for the divider valves, connection of the lines to selected ports thereof, and operating pump 192 during the desired operating modes of harvester 10, satisfactory lubrication of the heavy grease areas is achieved.

It will be understood that changes in the details, materials, steps, and arrangements of parts which have been described and illustrated to explain the nature of the invention will occur to and may be made by those skilled in the art upon a reading of this disclosure within the principles and scope of the invention. The foregoing description illustrates the preferred embodiment of the invention; however, concepts, as based upon the description, may be employed in other embodiments without departing from the scope of the invention. Accordingly, the following claims are intended to protect the invention broadly as well as in the specific form shown.

What is claimed is

1. In a cotton harvester having a plurality of harvesting mechanisms, each harvesting mechanism having at least one light grease receiving area including a picker bar having a plurality of rotatably driven picker spindles, and at least one heavy grease receiving area including a cam and a roller arrangement and a gear arrangement for drivingly oscillating the picker bar, and an automatic lubrication system for periodically lubricating the light grease receiving area with a light grease at a first pressure, the improvement comprising:
a heavy grease reservoir on the harvester for receiving a quantity of a heavy grease;
a pump on the harvester having an inlet connected to the heavy grease reservoir and a discharge, the pump being operable for drawing the heavy grease from the heavy grease reservoir and discharging the heavy grease from the discharge at a second pressure which is substantially greater than the first pressure, the discharge being connected to one end of at least one high pressure lubricant line having another end having at least one outlet disposed for discharging the heavy grease to the at least one heavy grease receiving area; and
a controller connected to the pump for operating the pump for causing the heavy grease to flow through the at least one high pressure lubricant line and discharge through the opening to the at least one heavy grease receiving area.

2. The cotton harvester of claim 1 further comprising a second heavy grease receiving area on a frame of the harvester including at least one fan bearing, the improvement including a high pressure lubricant line having one end connected to the pump discharge for receiving the heavy grease therefrom and another end having an outlet disposed for discharging the heavy grease to the at least one fan bearing when the pump is operated.

3. The cotton harvester of claim 2 further comprising a third heavy grease receiving area including at least one pivot for raising and lowering the at least one harvesting mechanism, the improvement including a high pressure lubricant line having one end connected to the pump discharge for receiving the heavy grease therefrom and an outlet disposed for discharging the heavy grease to the at least one pivot when the pump is operated.

4. The cotton harvester of claim 3, wherein the improvement further comprises at least one divider valve connected to the lines operable for sequentially directing the flow of the heavy grease through the lines, respectively.

5. The cotton harvester of claim 1, wherein the controller periodically operates the pump for causing the heavy grease to flow through the at least one high pressure lubricant line and discharge through the outlet to the at least one heavy grease receiving area while the harvesting mechanisms are operating in a harvesting mode.

6. The cotton harvester of claim 1 wherein the light grease is a NLGI 00 rated grease, and the heavy grease is selected from the group consisting of a NLGI 1 rated grease, a NLGI 2 rated grease, and a NLGI 3 rated grease.

7. An automatic on-board light grease and heavy grease lubrication system for a cotton harvester, the cotton harvester having a plurality of harvesting mechanisms, each harvesting mechanism having at least one light grease receiving area including a picker bar having a plurality of rotatably driven picker spindles, and at least one heavy grease receiving area including a cam and a roller arrangement and a gear arrangement for drivingly oscillating the picker bar, the lubrication system comprising:
a light grease reservoir for receiving a quantity of a light grease;
a light grease pump having an inlet connected to the light grease reservoir and a discharge, the light grease pump being operable for drawing the light grease from the light grease reservoir and discharging the light grease from the discharge at a first pressure, the discharge being connected to one end of at least one light lubricant line having another end including at least one outlet disposed for discharging the light grease to the at least one light grease receiving area;
a heavy grease reservoir for receiving a quantity of a heavy grease;
a heavy grease pump having an inlet connected to the heavy grease reservoir and a heavy grease discharge, the heavy grease pump being operable for drawing the heavy grease from the heavy grease reservoir and discharging the heavy grease from the heavy grease discharge at a second pressure which is substantially greater than the first pressure, said heavy grease discharge being connected to one end of at least one high pressure lubricant line having another end including at least one outlet disposed for discharging the heavy grease to the at least one heavy grease receiving area; and
a controller connected to a source of energy and to the heavy grease pump for operating the heavy grease pump for causing the heavy grease to flow through the at least one high pressure lubricant line and discharge through the opening thereof to the at least one heavy grease receiving area.

8. The system of claim 7, wherein the first pressure is less than about 200 psi and the second pressure is greater than about 1000 psi.

9. The system of claim 7, wherein the light grease pump is controllable to operate to cause the light grease to be discharged to the at least one light grease receiving area during a non-harvesting operating period, and the heavy grease pump is automatically controlled to cause the heavy grease to be discharged to the at least one heavy grease receiving area periodically during the operation of the harvesting mechanisms in a harvesting mode.

10. The system of claim 7 wherein the harvester has a frame including at least one heavy lubricant receiving area thereon, and the system includes at least one high pressure lubricant line having one end connected to the discharge of the heavy grease pump and another end including at least one outlet disposed for discharging the heavy grease to the at least one heavy grease receiving area on the frame.

11. The system of claim 10 wherein the at least one heavy grease receiving area of the frame includes a fan bearing.

12. The system of claim 7 wherein the harvester includes a tool bar and lift assembly including a plurality of pivots for supporting and allowing pivotally moving the harvesting mechanisms relative to a frame of the harvester, and wherein the system includes a plurality of high pressure lubricant lines having ends connected to the discharge of the heavy grease pump and ends including outlets disposed for discharging the heavy grease to the plurality of pivots, respectively.

13. The system of claim 9 wherein the heavy grease receiving areas are lubricated with the heavy grease at about hourly intervals during the operation of the harvesting units.

14. The system of claim 10, further comprising at least one divider valve connected to the high pressure lubricant lines operable for sequentially directing the flow of the heavy grease through selected of the lines to the heavy grease receiving areas.

15. A cotton harvester comprising:
a plurality of harvesting mechanisms, each harvesting mechanism having at least one light grease receiving area including a picker bar having a plurality of rotatably driven picker spindles, and at least one heavy grease receiving area including a cam and a roller arrangement and a gear arrangement for drivingly oscillating the picker bar;
a lift assembly connected to a frame of the harvester and supporting the plurality of harvesting mechanisms, the lift assembly including a plurality heavy grease receiving areas including a plurality of pivots allowing pivotally moving the harvesting mechanisms relative to the frame;
at least one fan connected by ducts to the harvesting mechanisms and having heavy grease receiving areas including fan bearings;
a light grease reservoir for receiving a quantity of a light grease;
a light grease pump having an inlet connected to the light grease reservoir and a discharge, the light grease pump being operable for drawing the light grease from the light grease reservoir and discharging the light grease from the discharge at a first pressure, the discharge being connected to inlet ends of a plurality of light lubricant lines having outlets disposed for discharging the light grease to the at least one light grease receiving area of the harvesting mechanisms, respectively;
a heavy grease reservoir for receiving a quantity of a heavy grease;
a heavy grease pump having an inlet connected to the heavy grease reservoir and a heavy grease discharge, the heavy grease pump being operable for drawing the heavy grease from the heavy grease reservoir and discharging the heavy grease from the heavy grease discharge at a second pressure which is substantially greater than the first pressure, said heavy grease discharge being connected to inlet ends of a plurality of high pressure lubricant lines having outlets disposed for discharging the heavy grease to the heavy grease receiving areas; and
a controller connected to a source of energy and to the heavy grease pump for operating the heavy grease pump for causing the heavy grease to flow through the high pressure lubricant lines and discharge through the outlets thereof to the heavy grease receiving areas.

16. The cotton harvester of claim 15, wherein the light grease pump is controllable to cause the light grease to be discharged to the light grease receiving areas during a non-harvesting operating period, and the heavy grease pump is automatically controlled to cause the heavy grease to be discharged to the heavy grease receiving areas periodically during the operation of the harvesting mechanisms in a harvesting mode.

17. The cotton harvester of claim 15, wherein the first pressure is less than about 200 psi and the second pressure is greater than about 1000 psi.

18. The cotton harvester of claim 15 wherein the light grease is a NLGI 00 rated grease, and the heavy grease is selected from the group consisting of a NLGI 1 rated grease, a NLGI 2 rated grease, and a NLGI 3 rated grease.

19. The cotton harvester of claim 16, wherein the heavy grease is discharged to each of the heavy grease receiving areas about hourly during the operation of the harvesting mechanisms in the harvesting mode.

20. The cotton harvester of claim 15, including divider valves disposed for proportionally distributing the heavy grease through the high pressure lubricant lines.
